(19) United States
(12) Patent Application Publication
(10) Pub. No.: US 2017/0053574 A1
(43) Pub. Date: Feb. 23, 2017

(54) Vehicle Mounting Signage System

(71) Applicant: Stephen Byrd, Troutman, NC (US)

(72) Inventor: Stephen Byrd, Troutman, NC (US)

(21) Appl. No.: 14/829,899

(22) Filed: Aug. 19, 2015

(51) Int. Cl. G09F 21/04; G09F 7/18

(52) U.S. Cl. CPC G09F 21/04; G09F 7/18; G09F 2021/041; G09F 2007/1865; G09F 2007/1852

(57) ABSTRACT

A vehicle mounted signage system includes a vehicle that has an upper side, a front end and a rear end. A base has a top side and a bottom side. A coupler attaches the bottom side to the upper side. A plate has a front side, a back side and a perimeter edge. The front end faces towards the front end and indicia may be positioned on the front and back sides. The perimeter edge includes a bottom edge. A connector pivotally couples the plate to the top side such that the bottom edge is adjacent to the top side. The connector retains the plate in an upright position when there is a lack of force pressing against the front side. The connector allows the plate to pivot such that the back side is facing downwardly towards the upper side when force is applied to the front side.

### BACKGROUND OF THE DISCLOSURE

Field of the Disclosure

The disclosure relates to vehicle signage devices and more particularly pertains to a new vehicle signage device for positioning on and drawing attention to a display mounted on an upper side of a vehicle.

### SUMMARY OF THE DISCLOSURE

An embodiment of the disclosure meets the needs presented above by generally comprising a vehicle that has an upper side, a front end and a rear end. The vehicle has a longitudinal axis extending through the front and rear ends. A base has a top side and a bottom side. A coupler is attached to the bottom side and releasably attaches the base to an upper surface of the upper side. A plate has a front side, a back side and a perimeter edge. The front end faces towards the front end and indicia may be positioned on the front and back sides. The perimeter edge includes a bottom edge. A connector pivotally couples the plate to the top side such that the bottom edge is adjacent to the top side. The connector retains the plate in an upright position when there is a lack of force pressing against the front side. The connector allows the plate to pivot such that the back side is facing downwardly towards the upper side when force is applied to the front side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a vehicle mounted signage system according to an embodiment of the disclosure.

FIG. 2 is a bottom view of an embodiment of the disclosure.

FIG. 3 is a top view of an embodiment of the disclosure.

FIG. 4 is a rear view of an embodiment of the disclosure.

FIG. 5 is a side in-use view of an embodiment of the disclosure.

### DESCRIPTION OF THE PREFERRED EMBODIMENT

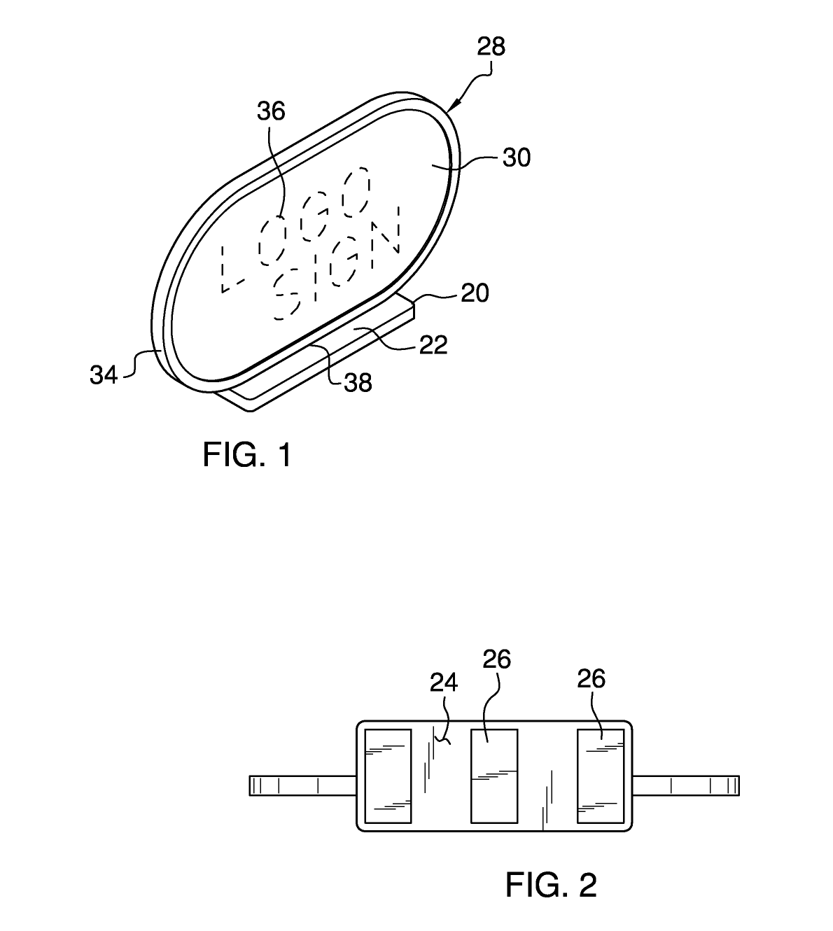

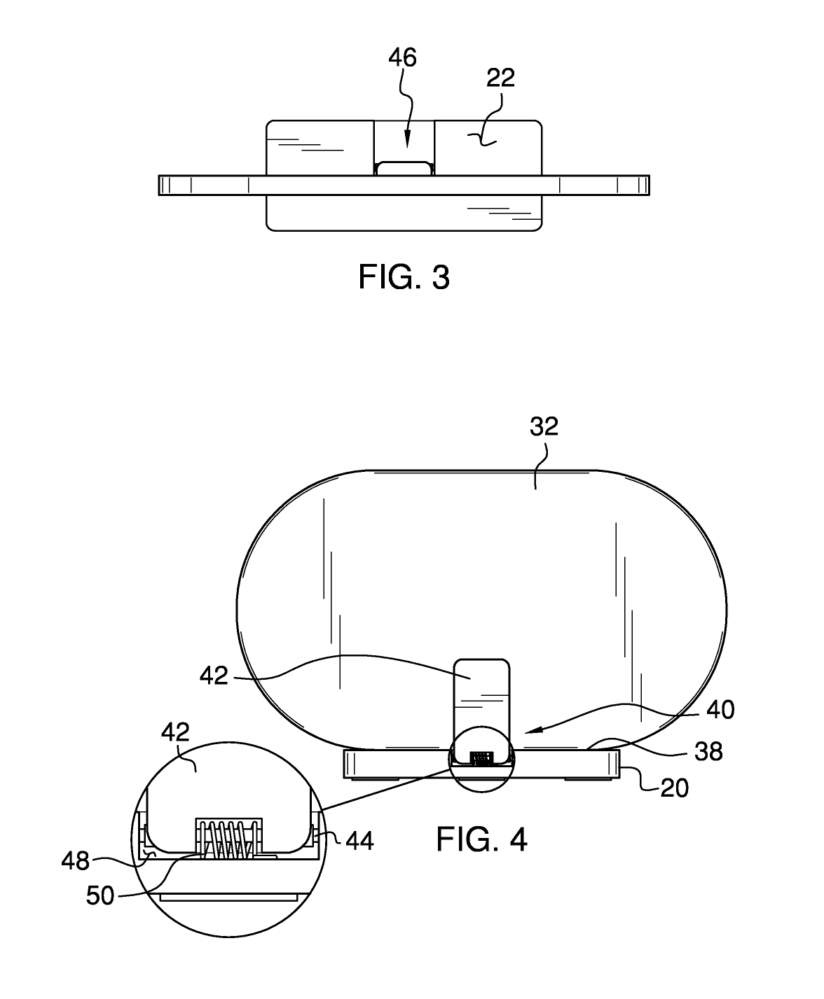

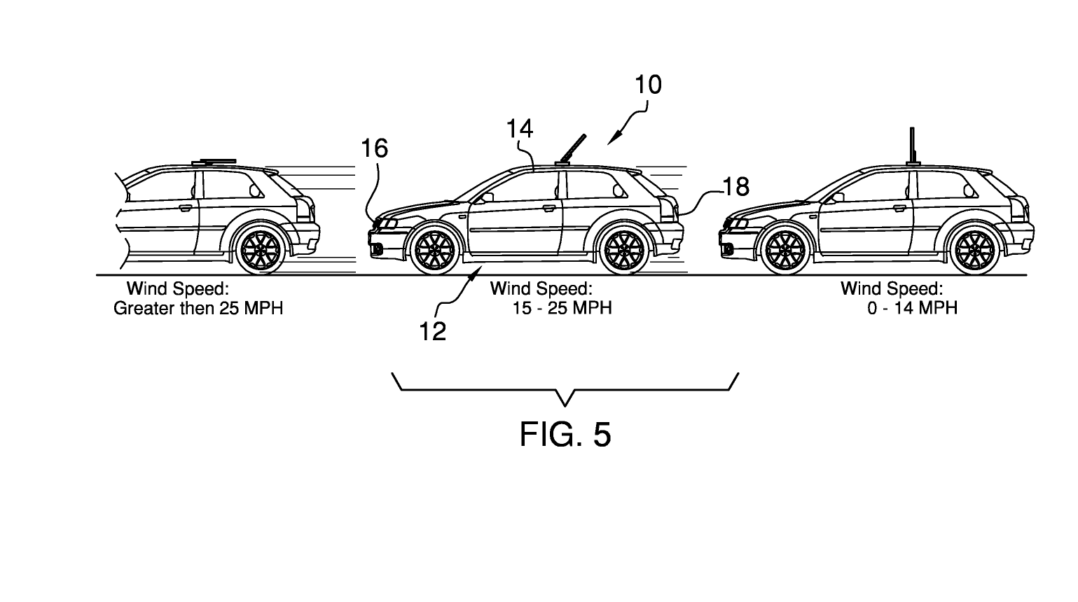

With reference now to the drawings, and in particular to FIGS. 1 through 5 thereof, a new vehicle signage device embodying the principles and concepts of an embodiment of the disclosure and generally designated by the reference numeral 10 will be described.

As best illustrated in FIGS. 1 through 5, the vehicle mounted signage system 10 generally comprises a vehicle 12 which has an upper side 14, a front end 16 and a rear end 18. The term “upper side” is intended to include a hood, roof and trunk lid (if provided) of the vehicle. The vehicle 12 has a longitudinal axis extending through the front 16 and rear 18 ends. The vehicle 12 may comprise any conventional vehicle but will generally be one in which adjacent vehicles can easily see the upper side 14 or elements extending upwardly therefrom.

A base 20 is provided which has a top side 22 and a bottom side 24. A coupler 26 is attached to the bottom side 24 and releasably attaches the base 20 to an upper surface of the upper side 14. The coupler 26 may comprise any conventional means for coupling an object to a vehicle upper side 14. Therefore it may include a magnet, suction cup, brackets that engage sides of the upper side and the like. More permanent couplers 26, such as threaded fasteners or adhesives, may also be utilized.

A plate 28 has a front side 30, a back side 32 and a perimeter edge 34. The front side 30 faces towards the front end 16. The front 30 and back 32 sides are configured to display indicia 36 and may include personal messages or advertisements. The perimeter edge 34 includes a bottom edge 38 and a connector 40 pivotally couples the plate 28 to the top side 22 such that the bottom edge is 38 adjacent to the top side 22. The connector 40 retains the plate 28 in an upright position when there is a lack of force pressing against the front side 30, allows the plate 28 to pivot such that the back side 32 is facing downwardly towards the upper side 14 when force is applied to the front side 30, and may prevent the plate 28 from pivoting forward such that an angle between the base 20 and the front side 30 remains at least equal to 90° as shown in FIG. 1. The amount of force required to pivot the plate relative to the base 20 is dependent upon the size of the plate 28 and resistance provided by the connector 40. Generally, the resistance should be such that that front side 30 of the plate 28 is angled with respect to the base 20 between 90° and 120° when wind speed against the plate 28 is less than 15 mph, between 120° and 150° when the wind speed is between 15 mph and 25 mph and between 150° and 180° when the wind speed is greater than 25 mph.

The plate 28 may have any required size. However, generally, the plate 28 will have a length between lateral edges thereof that is less than 12.0 inches and height extending upwardly from the bottom edge 38 being less than 12.0 inches.

The connector 40 includes an arm 42 that is attached to the plate 28 and extends downwardly from the bottom edge 38. An axle 44 extends through the arm 42 and is attached to the base 20. The axle 44 is positioned within a trough 46 in the top side 22. The trough 46 extends rearwardly from the axle 44. The trough 46 has a forward wall 48 abutting the arm 42 when the arm 42 is in a vertical orientation. The trough 46 receives the arm 42 when the plate 28 is in a horizontal orientation having the back side 32 facing downward. A spring 50 is mounted on the axle 44 and engages the arm 42 to retain the arm 42 in the vertical orientation.

In use, the base 20 is attached to the upper side 14 of the vehicle 12 and the plate 28 extends upwardly from the base 20 so that it is easily viewable. As the vehicle 12 increases and decreases speed, the plate 28 will pivot relative to the upper side 14 and thereby will attract attention to the plate 28 and the indicia thereon.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle signage system comprising:
a vehicle having an upper side, a front end and a rear end, said vehicle having a longitudinal axis extending through said front and rear ends;
a base having a top side and a bottom side;
a coupler being attached to said bottom side and releasably attaching said base to an upper surface of said upper side; and
a plate having a front side, a back side and a perimeter edge, said front side facing towards said front end, wherein said front and back sides are configured to display indicia, said perimeter edge including a bottom edge, a connector pivotally coupling said plate to said top side such that said bottom edge is adjacent to said top side, said connector retaining said plate in an upright position when there is a lack of force pressing against said front side, said connector allowing said plate to pivot such that said back side is facing downwardly towards said upper side when force is applied to said front side.

2. The vehicle signage system according to claim 1, wherein said coupler comprises a magnet.

3. The vehicle signage system according to claim 1, wherein said connector prevents said plate from pivoting forward such that an angle between said base and said front side remains at least equal to 90°.

4. The vehicle signage system according to claim 1, wherein said plate has a length being lateral edges thereof being less than 12.0 inches, said plate having a height extending upwardly from said bottom edge being less than 12.0 inches.

5. The vehicle signage system according to claim 1, wherein said connector includes:
an arm being attached to said plate and extending downwardly from said bottom edge;
an axle extending through said arm and being attached to said base; and
a spring being mounted on said axle and engaging said arm to retain said arm in said vertical orientation.

6. The vehicle signage system according to claim 5, wherein said axle is positioned within a trough in said top side, said trough extending rearwardly from said axle, said trough having a forward wall abutting said arm when said arm is in a vertical orientation, said trough receiving said arm when said plate is in a horizontal orientation having said back side facing downward.

7. A vehicle signage system comprising:
a vehicle having a upper side, a front end and a rear end, said vehicle having a longitudinal axis extending through said front and rear ends;
a base having a top side and a bottom side;
a coupler being attached to said bottom side and releasably attaching said base to an upper surface of said upper side, said coupler comprising a magnet;
a plate having a front side, a back side and a perimeter edge, said front side facing towards said front end, wherein said front and back sides are configured to display indicia, said perimeter edge including a bottom edge, a connector pivotally coupling said plate to said top side such that said bottom edge is adjacent to said top side, said connector retaining said plate in an upright position when there is a lack of force pressing against said front side, said connector allowing said plate to pivot such that said back side is facing downwardly towards said upper side when force is applied to said front side, said connector preventing said plate from pivoting forward such that an angle between said base and said front side remains at least equal to 90°, said plate having a length being lateral edges thereof being less than 12.0 inches, said plate having a height extending upwardly from said bottom edge being less than 12.0 inches, said connector including:
an arm being attached to said plate and extending downwardly from said bottom edge;
an axle extending through said arm and being attached to said base, said axle being positioned within a trough in said top side, said trough extending rearwardly from said axle, said trough having a forward wall abutting said arm when said arm is in a vertical orientation, said trough receiving said arm when said plate is in a horizontal orientation having said back side facing downward; and
a spring being mounted on said axle and engaging said arm to retain said arm in said vertical orientation.
